(19) United States
(12) Patent Application Publication
(10) Pub. No.: US 2026/0105082 A1
(43) Pub. Date: Apr. 16, 2026

(54) SYSTEMS AND METHODS FOR RETRIEVAL AUGMENTED GENERATION USING QUESTION DECOMPOSITION AND CLASSIFICATION

(71) Applicant: Salesforce, Inc., San Francisco, CA (US)

(72) Inventors: Kaige Xie, Palo Alto, CA (US); Prafulla Kumar Choubey, San Jose, CA (US); Chien-Sheng Wu, Mountain View, CA (US)

(21) Appl. No.: 19/253,675

(22) Filed: Jun. 27, 2025

Related U.S. Application Data
(60) Provisional application No. 63/707,438, filed on Oct. 15, 2024.

(51) Int. Cl. G06F 16/3329; G06F 40/35

(52) U.S. Cl. CPC G06F 16/33295; G06F 40/35

(57) ABSTRACT

Embodiments described herein provide a RAG framework including a question decomposition module to decompose an open-ended question and a classification module to evaluate whether a RAG LLM-generated answer accurately address each decomposed sub-question. Specifically, a question received from a user may be decomposed into subquestions using a neural network based language model. Then, each subquestion may be classified, e.g., as core, background, or follow-up. Text chunks may be retrieved based on the classifications and the subquestions, and a neural network based language model may generate a response to the user question based on the retrieved text chunks. Finally, a rating may be determined, where the rating is indicative of whether the response answers a subquestion in the plurality of subquestions. The rating may thus be used as feedback for a RAG LLM to revise and/or re-generate the answer to the user question.

### CROSS REFERENCE(S)

The instant application is a nonprovisional of and claim priority under 35 U.S.C. 119 to U.S. provisional application No. 63/707,438, filed Oct. 15, 2024, which is hereby expressly incorporated by reference herein in its entirety.

### TECHNICAL FIELD

The embodiments relate generally to machine learning systems for question response, and more specifically to retrieval augmented generation using question decomposition and classification.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

Some AI agents may employ retrieval-augmented generation (RAG) systems to generate text responses. RAG systems retrieve contextually relevant source documents based on a user-provided question. Then a RAG system uses both the user-provided question and the retrieved documents to generate a textual response. However, existing retrieval-augmented generation systems have difficulty answering certain types of user queries, such as open-ended queries that lack definitive answers and require coverage of multiple sub-topics. For example, a RAG system may not generate a satisfactory answer to “How is climate change affecting the Earth?” It remains challenging for a RAG to provide an answer that covers different aspects covered by the question.

### BRIEF DESCRIPTION OF THE DRAWINGS

FIG. 1 shows an example operation of an LLM based AI agent, according to embodiments of the present disclosure.

FIG. 2 is a simplified diagram illustrating a retrieval-augmented generation framework according to some embodiments.

FIG. 3A is a simplified diagram illustrating a computing device implementing the retrieval-augmented generation framework described in FIG. 1, according to some embodiments.

FIG. 3B is a simplified diagram illustrating a neural network structure, according to some embodiments.

FIG. 4 is a simplified block diagram of a networked system suitable for implementing the retrieval-augmented generation framework described in FIG. 1 and other embodiments described herein.

FIG. 5 is an example logic flow diagram illustrating a method of retrieval-augmented generation based on the framework shown in FIG. 1, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

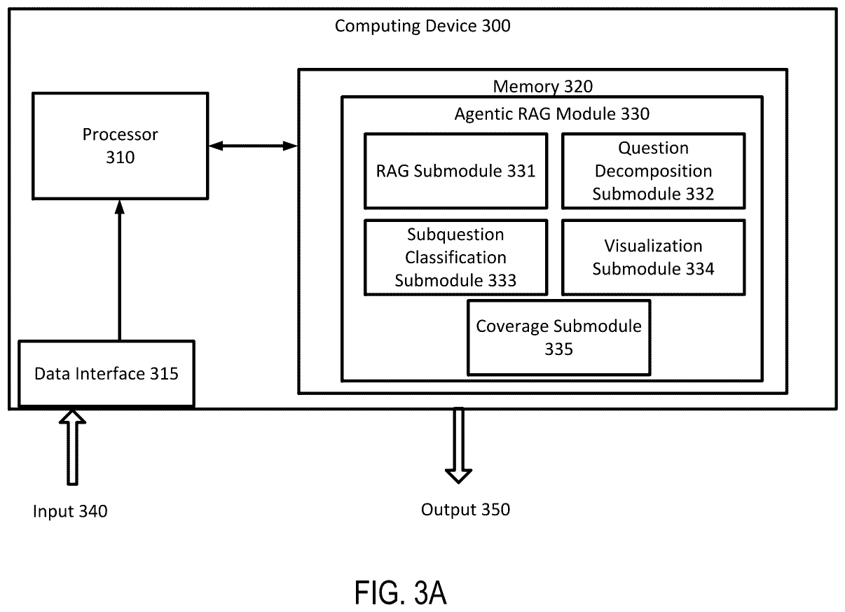

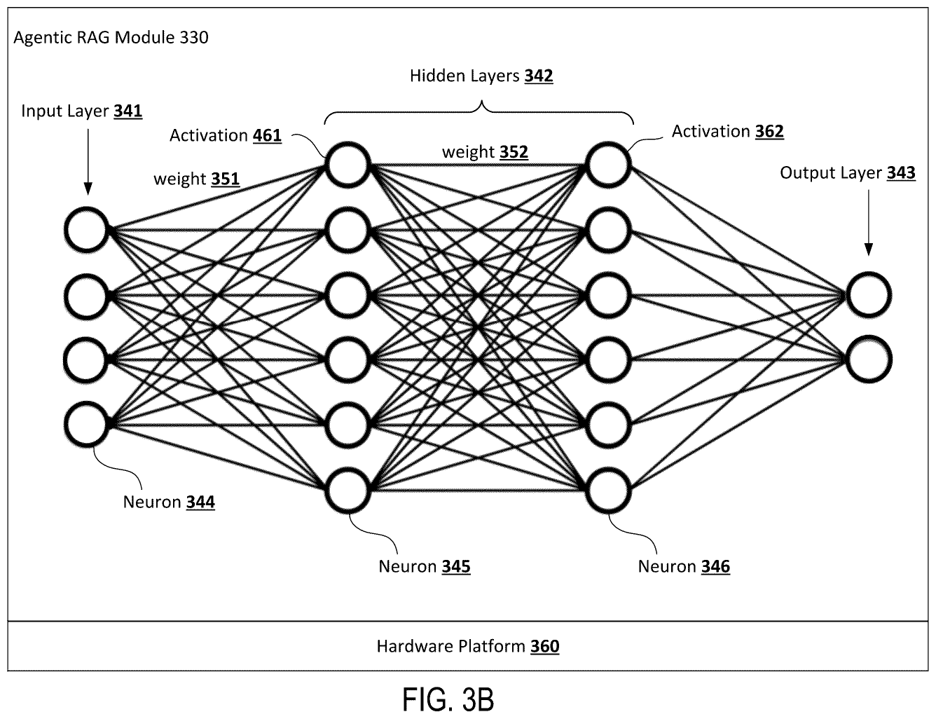

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Retrieval-augmented generation (RAG) combines retrieval models to retrieve relevant documents from a database and generate a response to a user query based on the retrieved documents without requiring extensive retraining. However, existing RAG systems have difficulty answering certain types of user queries, such as open-ended queries that lack definitive answers and require coverage of multiple sub-topics pose a challenge for existing RAG systems. For example, for a question of “How is climate change affecting the Earth?”, it remains challenging for a RAG to provide an answer that covers different aspects covered by the question.

Embodiments described herein provide a RAG framework including a question decomposition module to decompose an open-ended question and a classification module to evaluate whether a RAG LLM-generated answer accurately address each decomposed sub-question. Specifically, a question received from a user may be decomposed into subquestions using a neural network based language model. Then, each subquestion may be classified, e.g., as core, background, or follow-up. Text chunks may be retrieved based on the classifications and the subquestions, and a neural network based language model may generate a response to the user question based on the retrieved text chunks. Finally, a rating may be determined, where the rating is indicative of whether the response answers a subquestion in the plurality of subquestions. The rating may thus be used as feedback for a RAG LLM to revise and/or re-generate the answer to the user question.

In this way, an AI conversation agent may avoid answers that include extraneous information, such as information that might belong in a response to a follow-up response or an explanation of background context. Neural network technology in AI conversation agent is improved. Risk of unhelpful and/or irrelevant information being provided in various practical applications such as healthcare, autonomous driving, and/or the like is reduced.

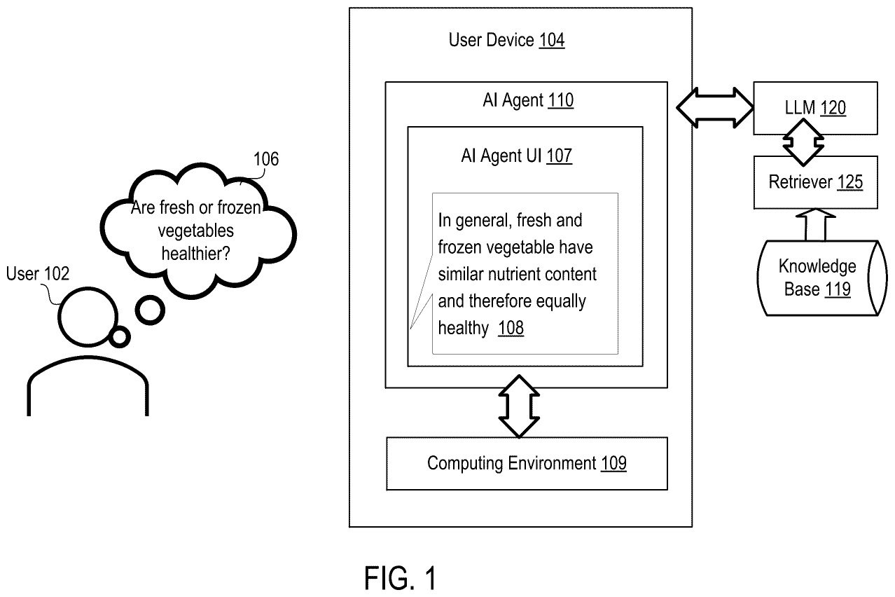

FIG. 1 shows an example operation of an LLM based AI agent handling an open-ended and complex question, according to embodiments of the present disclosure. An LLM-based AI agent 110 may be implemented on a user device 104 interacting with the computing environment 109 to receive a user task request 106 as a natural language input, typically through a chat or command interface 107. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 3B.

In some embodiments, the request 106 may be a complex and/or open-ended question and/or the like. In that case, the AI agent 110 may further analyze and decompose the question of such requests, e.g., according to embodiments described herein.

For example, the user 102 may ask the AI agent “Are fresh or frozen vegetables healthier” 106. If the AI agent 110 processes the task request 106 at an LLM 120, extracts key information and retrieves information from the knowledge base 119 via its retriever 125 so as to generate a response, such response may likely include extraneous information, e.g., the AI agent 110 may retrieve background information relating to different aspects of the question and generate a response focused more on the background information than answering the user's question. For example, the LLM 120 might retrieve information about the nutrition content of fresh and frozen vegetables and generate a response describing the nutrition content, as opposed to answering the question that asks for a comparison of which is healthier.

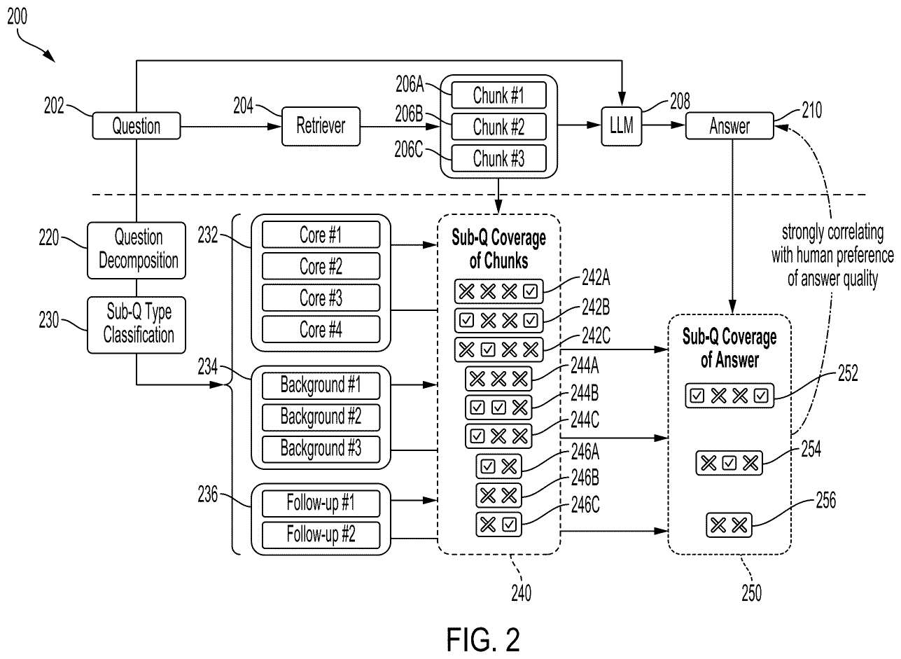

In contrast, the LLM 120 and retriever 125 may be combined with further processing of the user-query and analysis of retrieved documents to focus the LLM's response on core aspects of the user question. For example, a core question related to user question 106 may be “What makes a vegetable healthy for humans?” By ensuring core questions are answered that are related to user question 106, the response of the LLM 120 may be improved. Additional information relating to decomposing and classifying user questions is described below in relation to FIG. 2.

In one embodiment, the AI agent 110 may be implemented as an agent for resolving network issues, e.g., the AI agent 110 may be integrated at a network server to perform autonomous diagnostic, triage, and remediation tasks. In that case, the AI agent 110 may receive an open-ended query 106, e.g., “why is the Internet speed so slow?,” and generate a response to the query. For example, the AI agent 110 may generate executable system commands (e.g., Python scripts for API calls, etc.) to collect data from various sources, such as logs, telemetry, alert messages, and configuration files, often through an interface like a REST API or streaming pipeline. In this way, the LLM 120 may parse and interpret these inputs using natural language understanding and pattern recognition, identifying anomalies, errors, or performance degradations. For instances, the LLM 120 may correlate repeated packet drops with a recent router firmware update or recognize a misconfigured DNS entry causing service disruptions.

In one embodiment, the LLM 120 may operate with the retriever 125 to retrieve from the knowledge base 119 of troubleshooting procedures and contextual knowledge of the network environment, based on which the LLM 120 may generate a text response summarizing causes and/or remedial actions relating to Internet speed degradation. The text response may similarly be generated, evaluated, and improved using the pipeline 200 described below in FIG. 2.

In one embodiment, in addition to generating a text response 108, the LLM 120 may again generate system commands of resolution steps or autonomously execute predefined commands through automation scripts. For example, the AI agent 110 may transmit a command to a network gateway to block anomalous traffic from certain Internet addresses to prevent unwanted traffic causing congestion at the gateway.

FIG. 2 is a simplified diagram illustrating a retrieval-augmented generation (RAG) framework 200 to support the AI agent 110 in FIG. 1, according to some embodiments. In some embodiments, RAG framework 200 generates an answer 210 to a question 202, such as a question provided by a user to an AI agent, e.g., as depicted in FIG. 1 and described above. RAG framework 200 may include a retriever 204, large language model (LLM) 208, question decomposer 220, and subquestion classifier 230.

In one embodiment, retriever 204 may receive a question 202 and retrieve one or more text chunks, e.g., first chunk 206A, second chunk 206B, and third chunk 206C. Question 202 may be received from a user. For example, as shown in FIG. 1, user 102 may input a question in the form of task request 106 to AI agent 110. In some embodiments, a retriever 204 may include an encoder and/or embedder of an LLM. In some embodiments, retriever 204 may include the encoder and/or embedder of LLM 208/The retriever 204 may embed/encode the user question. Then the embedded/encoded user question may be used to search for and retrieve contextually relevant documents, websites, articles, or any other textual material. Retriever 204 may select relevant chunks, e.g., relevant paragraphs or sentences, from larger documents. While three chunks 206A-C are depicted in FIG. 2, it should be understood that any number of chunks, both less and more than three, may be retrieved by retriever 204.

LLM 208 may receive retrieved chunks 206A-C and generate an answer 210 according to the user question 202 and the chunks 206A-C. The input to LLM 208 may be in the form of a structured prompt that includes the question 202 and chunks 206A-C.

In some embodiments, a RAG system may include a question decomposer 220 and/or subquestion classifier 230. A question decomposer 220 may decompose the user question 202 into one or more subquestions. In some embodiments, question decomposer 220 may include a large language model, e.g., the same or different than LLM 208, which is prompted to generate the one or more subquestions that comprise the question 202. A complex question may be decomposed into a larger number of subquestions, while a simpler question may be decomposed into a smaller number of subquestions. For instance, to address the question “Are fresh or frozen vegetables healthier?” sufficiently, several sub-questions may be identified and answered, such as #1 “How does the freezing process affect the nutritional content of vegetables?”, #2 “What are the common methods used to freeze vegetables?”, and #3 “What are the cost and taste differences between fresh and frozen vegetables?”.

In some aspects, the multi-faceted information necessary for answering a given question is equivalent to the overall information that can be covered by multiple subquestions. However, while gathering more information in response to various subquestions may be beneficial, in some embodiments, not all of the information for each subquestion should be treated equally, as their relevance and importance to the original question may vary. For example, sub-question #1 may be the most crucial, #2 may provide helpful context, and #3 may encourage thinking one step ahead, or alternatively, it might be a question a user asks as a follow-up. For example, a question such as “How does global warming impact extreme weather events?” would be fairly complicated requiring multiple subquestions to be answered to generate a comprehensive response. On the other hand, a question such as “Is an apple a fruit?” may not require any subquestions to give a complete response.

In one example, a prompt for question decomposition may be:

Decompose the following complex question into a collection of around
20 sub-questions that you think would be relevant to answer the complex
question fully.
Complex question: $question
Collection of sub-questions:

In some embodiments, question decomposer 220 may first come up with a comprehensive collection of relevant sub-questions that can answer the main question fully, and then a subquestion classifier 230 may prompt an LLM, such as the LLM used to decompose the question or a specialized classifier, to classify subquestions into three types: core 232, background 234, and follow-up 236. In some embodiments, the three types of subquestions may be defined as follows:

| | |
|---|---|
| Core | A core sub-question is central to the main topic and directly or |
| subquestion | partially addresses the main question. It is crucial for interpreting the |
| | logical reasoning of the main question and provides essential insights |
| | required for answering it. These sub-questions often involve multiple |
| | steps or perspectives, making them fundamental to generating |
| | comprehensive and well-rounded responses. |
| Background | A background sub-question is optional when answering the main |
| subquestion | question, but it can provide additional context or background |
| | information that helps clarify the main query. Its primary role is to |
| | support the understanding of the main topic by offering |
| | supplementary evidence or information, though it is not strictly |
| | necessary for addressing the core aspects of the question. |
| Follow-up | A follow-up sub-question is not needed to answer the main question. |
| subquestion | These sub-questions often arise after users receive an initial answer |
| | and seek further clarification or details. They may explore specific |
| | aspects of the response in greater depth, but their answers can |
| | sometimes be out-of-scope or beyond the focus of the original query. |

In one example, a prompt for classifying the subquestions generated by question decomposer may be:

Based on the sub-question's relevance and functional role in answering the complex
question, classify the sub-question into three types: core, background, and follow-up.
The definitions of these three sub-question types are:
(1) Core sub-questions:
They are central to the main topic and directly or partially address the complex
question.
They are crucial for interpreting the logical reasoning of the complex question and
provide essential insights required for answering the complex question.
They often involve multiple steps or perspectives, making them fundamental to
generating a comprehensive and well-rounded response to the complex question.
(2) Background sub-questions:
They are optional when answering the complex question, but they can provide
additional context or background information that helps clarify the complex question.
Their primary role is to support the understanding of the main topic by offering
supplementary evidence or information, though it is not strictly necessary for
addressing the core aspects of the complex question.
(3) Follow-up sub-questions:
They are not needed to answer the complex question.
They often arise after users receive an initial answer and seek further clarification or
details.
They may explore specific aspects of the response in greater depth, but their
answers can sometimes be out-of-scope or beyond the focus of the original complex
question.
Here are a few examples you can use for reference:
$few-shot-examples
Complex question: $question
Sub-question: $sub-question
Type classification:

In the table below are three examples of question decomposition and classification.

Main question: How can human activity affect the carbon cycle?

| | |
|---|---|
| Core subquestions | What human activities contribute to carbon emissions? |
| | How does deforestation affect the carbon cycle? |
| | What role does the burning of fossil fuels play in the carbon |
| | cycle? |
| | How do agricultural practices impact the carbon cycle? |
| | What is the effect of urbanization on the carbon cycle? |
| | How do industrial processes alter the carbon cycle? |
| | What is the impact of increased carbon dioxide levels on global |
| | warming? |
| | How does the alteration of the carbon cycle affect ocean |
| | chemistry? |
| | How can changes in land use affect the carbon cycle? |
| | What are the effects of waste management and landfill |
| | operations on the carbon cycle? |
| | How do energy production methods influence the carbon cycle? |
| | How can reforestation and afforestation impact the carbon |
| | cycle? |
| Background | What is the carbon cycle and how does it function? |
| subquestions | What are the main components of the carbon cycle? |
| | What are the natural sources of carbon emissions? |
| Follow-up | What are the consequences of the carbon cycle disruption on |
| subquestions | wildlife? |
| | How does the carbon cycle influence climate change? |
| | What are the long-term effects of altered carbon cycles on |
| | Earth's ecosystems? |
| | What are some ways to mitigate human impact on the carbon |
| | cycle? |
| | What policies can be implemented to reduce carbon emissions? |

Main question: How does reading foster long-term learning?

| | |
|---|---|
| Core subquestions | How does the brain process and store information read from |
| | texts? |
| | How does reading comprehension contribute to knowledge |
| | retention? |
| | How does the complexity of text affect comprehension and |
| | memory retention? |
| | What role does prior knowledge and experience play in reading |
| | comprehension? |
| | How does note-taking while reading enhance long-term |
| | memory? |
| | What are the neurological benefits of regular reading? |
| | How does reading fiction versus non-fiction impact long-term |
| | learning? |
| | How does the frequency of reading affect long-term cognitive |
| | abilities? |
| | What role does visualization while reading play in memory |
| | retention? |
| | How can reading multiple sources on the same topic enhance |
| | understanding and retention? |
| | What are the long-term impacts of reading on academic |
| | performance? |
| | How does reading influence critical thinking and analytical |
| | skills over time? |
| | What strategies can be employed to improve reading habits for |
| | better long-term learning? |
| Background | What is the definition of long-term learning? |
| subquestions | What cognitive skills are involved in reading? |
| | How does active reading differ from passive reading? |
| Follow-up | What types of reading materials are most effective for long-term |
| subquestions | learning? |
| | What are the benefits of discussing or teaching others about |
| | what one has read? |
| | What are the effects of digital versus physical reading on |
| | learning? |
| | How does age affect the ability to learn from reading? |

Main question: Why is a starving individual more susceptible
to infectious disease than a well-nourished individual?

| | |
|---|---|
| Core subquestions | How does malnutrition affect the immune system? |
| | How does protein-energy malnutrition impact immune cell |
| | function? |
| | What role do micronutrients play in immune system function? |
| | Which micronutrients are most important for a healthy immune |
| | response? |
| | How does deficiency in specific micronutrients affect |
| | susceptibility to infections? |
| | How does malnutrition alter the physical barriers of the body |
| | that prevent infection? |
| | What is the impact of malnutrition on the gut microbiome? |
| | How does the alteration of the gut microbiome in malnourished |
| | individuals affect immune function? |
| | What are the physiological changes in a malnourished body that |
| | increase infection risk? |
| | How does malnutrition affect the healing process after an |
| | infection? |
| | How does the severity and duration of malnutrition affect the |
| | level of increased susceptibility to infectious diseases? |
| Background | What is the definition of malnutrition? |
| subquestions | What are the key components of the immune system? |
| | What are the statistics on infection rates in malnourished |
| | versus well-nourished populations? |
| Follow-up | What are common infectious diseases that affect malnourished |
| subquestions | individuals? |
| | How do socioeconomic factors contribute to malnutrition and |
| | increased susceptibility to infectious diseases? |
| | What interventions can reduce the impact of malnutrition on |
| | susceptibility to infectious diseases? |
| | How effective are nutritional supplements in restoring immune |
| | function in malnourished individuals? |
| | What are the long-term effects of childhood malnutrition on |
| | adult immune function? |
| | What policies are effective in combating malnutrition and thus |
| | reducing susceptibility to infectious diseases? |

In one embodiment, once a question 202 has been decomposed into core questions 232, background questions 234, and follow-up questions 236, the coverage of each subquestion by documents retrieved by retriever 204, e.g., chunks 206A-C. A coverage module may include chunk coverage module 240 which prompts an LLM to determine if a retrieved document includes information answers the subquestion. For example, coverage 242A by the first chunk 206A of each of the core questions 232 indicates that the first chunk only covers the fourth core question; coverage 242B by the second chunk 206B of each of the core questions 232 indicates that the second chunk only covers the first and fourth core question; coverage 242C by the third chunk 206C of each of the core questions 232 indicates that the third chunk only covers the second core question. Similarly for the background questions, coverage 244A by the first chunk 206A of each of the background questions 234 indicates that the first chunk does not cover any background question; coverage 244B by the second chunk 206B of each of the background questions 234 indicates that the second chunk covers the first and third background questions; coverage 244C by the third chunk 206C of each of the background questions 234 indicates that the third chunk only covers the first background question. And similarly for the follow-up questions, coverage 246A by the first chunk 206A of each of the follow-up questions 236 indicates that the first chunk covers the first follow-up question; coverage 246B by the second chunk 206B of each of the follow-up questions 236 indicates that the second chunk covers none of the follow-up questions; coverage 246C by the third chunk 206C of each of the follow-up questions 234 indicates that the third chunk covers the second follow-up question.

An example prompt for determining coverage of subquestions is given below:

You are given a piece of text and a question.
Judge if there exists any part of the given text that can answer the
question.
If you believe the question can be answered, identify the text fragment
that answers the question; otherwise, just return “None”.
Here are a few examples you can use for reference:
$few-shot-examples
Piece of text: $text
Question: $sub-question
Judgment:

A coverage module may include an answer coverage module 250. Answer coverage module 250 determines if the answer 210 includes an answer to each of the subquestions, e.g., core questions 232, background questions 234, and follow-up questions 236. A similar prompt to the one shown above may determine answer coverage, i.e., where the “Piece of text” is the answer 210, instead of the retrieved document. For example, coverage 252 by the answer 210 of each of the core questions 232 indicates that the answer only covers the first and fourth core questions; coverage 254 by the answer 210 of each of the background questions 234 indicates that the answer only covers the second background question; and coverage 256 by the answer 210 of each of the follow-up questions 236 indicates that the answer does not cover either follow-up question.

In some embodiments, the degree of coverage by the retrieved documents, may be used to determine if additional or alternative documents should be retrieved. For example, coverages 242A-C show that none of the three chunks 106A-C cover the third core question. In such cases, additional documents may be retrieved until each of the core questions is covered. Similar considerations may be made for the coverage of subquestions by the answer, i.e., where the answer fails to answer one of the core questions a new answer may be generated. In some aspects, this may accomplish by prompting the retriever 204 and/or LLM 208 to expand or revise the chunks and/or answer to cover an uncovered core question.

In some embodiments, coverage rates may be determined for the coverage of each type of subquestion: {c_{core}, c_{background}, c_{follow-up}}. For example, an answer that cover 3 out of 4 core questions will have c_{core}=75%. Similar coverage rates may be calculated for documents retrieved by the retriever. A coverage rate of 100% may be required before an answer is shown to a user by an AI agent. Thus, the answer could iteratively regenerated until a threshold coverage rate is reached.

In some embodiments, an answer rating may be determined by using a weighted sum of three coverage rates. This may be expressed mathematically as:

$$rating = {\sum }_{type} {w}_{type} * {c}_{type} \qquad ( 1 )$$

where w_{type} represents a weighting coefficient for each of the subquestion types. As an example selection, weight may be chosen to be w_{core}:w_{background}:w_{follow-up}=1:0.5: −1, respectively. In such a configuration of weights, core questions receive the highest wight, favoring higher coverage of the core questions, background questions have a weight lower than core questions and thus less important, and follow-up questions are given a negative weight, disfavoring coverage of follow-up questions by answers or retrieved documents. Providing an answer to a user may be conditioned on a threshold value for the rating being achieved by the answer and/or retrieved documents. For example, a rating of at least 1 may be required before providing an answer to a user. The threshold condition for the rating may be combined with other conditions, such as a 100% coverage rate for core questions.

While reference has been made to core, background, and follow-up questions, alternative or additional classifications may be used. For example, the answer to some subquestions could be harmful or dangerous and an answer should not be shown to a user that answers a harmful subquestion. In addition, other weighting values may be selected than the ones recited herein. In some embodiments, a user may be prompted to select the weights or otherwise indicate their preference for the focus of an answer to a complex questions, e.g., preferring only core subquestions be answered or preferring some background-related answers to the complex question. A user may indicate these preferences by changing the relative weights associated with different types of subquestions.

In one embodiment, coverage data 252 254 and 256 may serve as feedback for the RAG framework 200 to refine, re-generate and/or to ask follow up questions. For example, the coverage data 252, 254, 256, decomposed questions 232, 234, 236 and answer 210 may be combined as input to the LLM 208, which may in turn be fed with a prompt to revise answer 210 to improve coverage for the question 202, e.g., to retrieve additional contextual information to improve coverage, based on which to generate a revised answer. Alternatively, the LLM 208 may be prompted to ask a follow up question for a user based on the coverage data 252, 254, 256 so as to obtain user preference on what aspects an updated answer may focus on.

In one embodiment, the RAG framework 200 may be further improved with core sub-questions. For example, the strong correlation between core sub-question coverage and human judgments of answer quality motivates efforts to enhance RAG responses by incorporating core sub-questions directly into the RAG workflow. This augmentation can be applied at various stages, including query reformulation, retrieval, and answer generation.

In one embodiment, one approach focuses on augmenting the input query with a general definition of core sub-questions. In this method, the RAG system is instructed to identify the core sub-questions of a given main question and to address as many of them as possible in the generated response. While this strategy does not tailor the retrieval process to specific questions-since the same core sub-question definition is applied uniformly—it can help guide the generation phase by prompting the language model to concentrate on the essential components of the answer.

In another embodiment, a more direct approach involves augmenting the input query with the actual core sub-questions derived from question decomposition. By including these specific sub-questions in the query, the system improves retrieval recall and focuses the generation process. Explicitly embedding core sub-questions enables the retrieval module to access more relevant chunks and allows the language model to structure the response around these sub-components, increasing both precision and coverage.

To further improve retrieval, another technique retrieves relevant chunks separately for the original query and for each core sub-question. The resulting chunks are then merged into a single pool and reranked according to how well they cover the core sub-questions. The top-ranked chunks from this pool are selected for use in generating the final answer. This method increases the likelihood that the generated response will incorporate information that specifically addresses the core elements of the question.

A more comprehensive strategy enhances both retrieval and generation in a coordinated manner. For each core sub-question, the system retrieves top relevant chunks and generates an individual answer. These sub-answers are then aggregated and used as input for generating a final answer to the original question. This process ensures that the final response is explicitly informed by detailed, targeted responses to each core sub-question, resulting in a more complete and structured long-form answer. Example performance results of the enhanced RAG framework may be described below in relation to Table 4.

### Computer and Network Environment

FIG. 3A is a simplified diagram illustrating a computing device implementing the agentic RAG framework described in FIGS. 1-2 according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for agentic RAG module 330 that may be used to implement and/or emulate the systems and models, and/or to implement any of the methods described further herein. for agentic RAG module 330 may receive input 340 such as an input training data (e.g., complex or open-ended questions) via the data interface 315 and generate an output 350 which may be an answer covering preferred subquestions of the complex or open-ended questions.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as question, from a user via the user interface.

In some embodiments, the agentic RAG module 330 is configured to evaluate whether the retrieved documents and/or answer a question. The agentic RAG module 330 may further include RAG submodule 331 (e.g., similar to LLM 120, retriever 125, and knowledge base 119 in FIG. 1 and retriever 204 and LLM 208 in FIG. 2), question decomposition submodule 331 (e.g., similar to question decomposer 220 in FIG. 2), subquestion classification module 333 (e.g., similar to subquestion classifier 230 in FIG. 2), visualization submodule 334 configured to display an answer to a user, and coverage submodule 335 (e.g., chunk coverage module 240 and/or answer coverage module 250 in FIG. 2)

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the agentic RAG module 330 described in FIG. 3A, according to some embodiments. In some embodiments, the agentic RAG module 330 and/or one or more of its submodules 331-335 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as a complex question. The number of nodes (neurons) in the input layer 341 may be determined by the dimensionality of the input data (e.g., the length of a vector of a tokenized complex question). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the agentic RAG module 330 receives an input 340 of complex question and transforms the input into an output 350 of an answer covering one or more subquestions of the complex question. To perform the transformation, each neuron receives input signals, performs a weighted sum of the inputs according to weights assigned to each connection (e.g., 351, 352), and then applies an activation function (e.g., 361, 362, etc.) associated with the respective neuron to the result.

The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the agentic RAG module 330 and/or one or more of its submodules 331-335 may comprise the transformative neural network structure of layers of neurons, and weights and activation functions describing the non-linear transformation at each neuron. Such a neural network structure is often implemented on one or more hardware processors 310, such as a graphics processing unit (GPU). An example neural network may be a Transformer based LLM such as GPT, and/or the like.

In one embodiment, the agentic RAG module 330 and its submodules 331-335 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 120 or 208) may receive a natural language input (such as a question) and generate a natural language output (such as an answer to the question).

In one embodiment, the agentic RAG module 330 and its submodules 331-335 may be implemented by hardware, software and/or a combination thereof. For example, the agentic RAG module 330 and its submodules 331-335 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

For example, to deploy the agentic RAG module 330 and its submodules 331-335 and/or any other neural network models such as Transformer based LLM such as GPT described in FIGS. 1-2 onto hardware platform 360, the neural network based modules 330 and its submodules 331-335 may be optimized for deployment by converting it to a suitable format, such as ONNX or TensorRT, to improve performance and compatibility. Next, depending on the size and workload requirements for modules 330 and its submodules 331-335, hardware types may be chosen for deployment, e.g., processing capacity, GPU memory size, and/or the like. Frameworks and drivers for the chosen hardware 360 frameworks and drivers may thus be installed, such as PyTorch, TensorFlow, or CUDA, to support the hardware platform 360. Then, weights and parameters of the agentic RAG module 330 and its submodules 331-335 may be loaded to the hardware 360. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the agentic RAG module 330 and its submodules 331-335 may be deployed as a service, then they may be integrated with an API endpoint, using tools like Flask, FastAPI, or a cloud platform serverless services, and is accessible by a remote user via a network.

In another embodiment, some or all of layers 341, 342, 343 and/or neurons 342, 345, 346, and operations there between such as activations 361, 362, and/or the like, of the agentic RAG module 330 and its submodules 331-335 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the agentic RAG module 330 may generate, by at least one ASIC (such as a TPU, etc.) performing a multiplicative and/or accumulative operation for a neural network language model, a next token based at least in part on previously generated tokens, and in turn generate a natural language output representing the next-step action combining a sequence of generated tokens.

In one embodiment, the neural network based agentic RAG module 330 and one or more of its submodules 331-335 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as complex questions are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding answer to complex question) from the training data, to compute a loss function that measures the discrepancy between the predicted output and the expected output. For example, the loss function may be cross entropy, MMSE, or the like. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based agentic RAG module 330 and one or more of its submodules 331-335 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

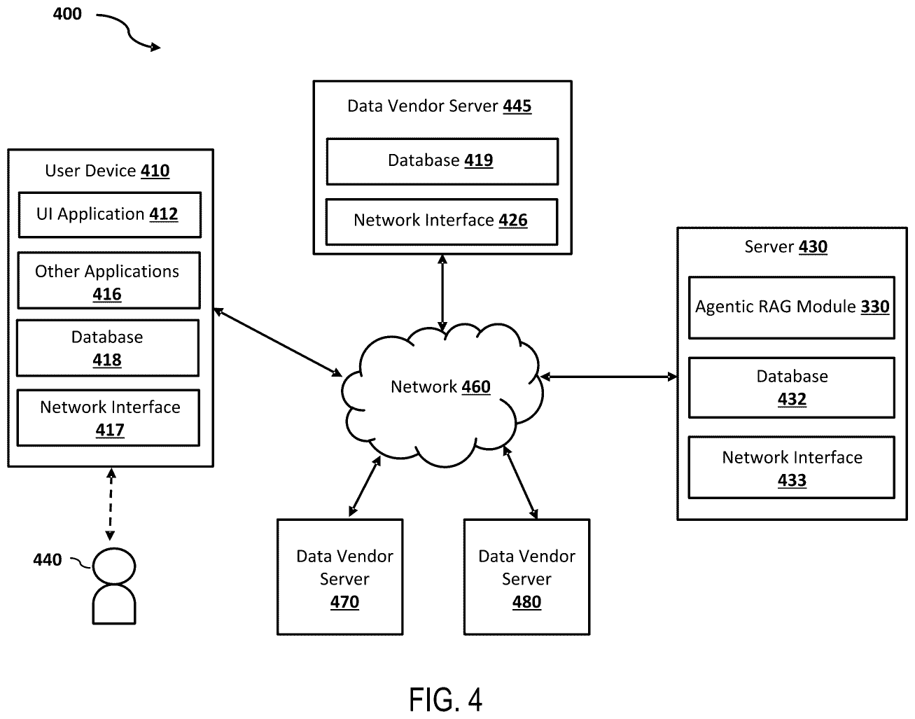

In some embodiments, agentic RAG module 330 and its submodules 331-335 may be housed at a centralized server (e.g., computing device 300) or one or more distributed servers. For example, one or more of agentic RAG module 330 and its submodules 331-335 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating an answer to a user-provided complex question.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in medical diagnostics, insurance, privacy, and other complex fields where complex questions are prevalent.

FIG. 4 is a simplified block diagram of a networked system 400 suitable for implementing the agentic RAG framework described in FIGS. 1-2 and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a response from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the agentic RAG module 330 (e.g., an LLM agent) at server 430. In at least one embodiment, a user operating user device 410 may enter a user utterance, e.g., via text or audio input, such as a question, uploading a document, and/or the like via the UI application 412. Such user utterance may be sent to server 430, at which agentic RAG module 330 may generate a response via the process described in FIGS. 1-3. The agentic RAG module 330 may thus cause a display of an answer at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view a response to the user question.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including question-answer pairs to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the agentic RAG module 330 and its submodules described in FIG. 3A. In some implementations, agentic RAG 330 may receive data from database 419 at the data vendor server 445 via the network 460 to generate an answer. The generated answer may also be sent to the user device 410 for review by the user 440 via the network 460.

In one embodiment, an AI agent implementing the agentic RAG module 330 and its submodules described in FIG. 3A may be built based on an LLM as described in FIG. 3B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the agentic RAG module 330 and its submodules described in FIG. 3A may be implemented as a cloud-based AI agent which may be accessed by user device 410 via a chatbot application, a web application, customer support or SaaS applications. In another implementation, a client-side AI agent component may be delivered from the server 430 to user device 410 for local installation such that the client-side AI agent may be installed and runs directly on the user's device. Such local AI agent on the user device 410 may be available offline to adapt to privacy-sensitive applications. In another implementation, the AI agent implementing the agentic RAG module 330 and its submodules described in FIG. 3A may adopt a hybrid cloud and client-based structure to balance computing speed, cost and privacy. For example, a local AI agent may handle basic AI queries locally, but complex queries may be sent to server 430 to process.

The database 432 may be stored in a transitory and/or non-transitory memory of the server 430. In one implementation, the database 432 may store data obtained from the data vendor server 445. In one implementation, the database 432 may store parameters of the agentic RAG module 330. In one implementation, the database 432 may store previously generated answers, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

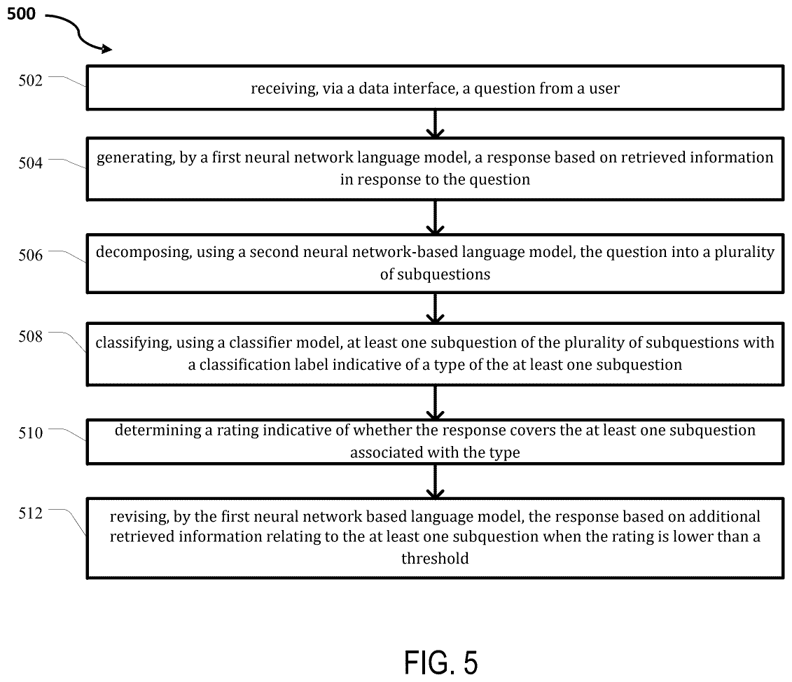

FIG. 5 is an example logic flow diagram illustrating a method of answer-generation using the framework shown in FIGS. 1-2, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the agentic RAG module 330 (e.g., FIGS. 3A and 4) that performs answer generation based on subquestion coverage.

In some embodiments, method 500 is performed by a system such as computing device 300, user device 410, server 430, or another device or combination of devices. Inputs (e.g., a complex question) may be received via a data interface such as data interface 315, network interface 417, network interface 433, or via a data interface that is integrated with a device. For example UI Application 412 may receive user inputs via a text input interface (e.g., keyboard), audio input (e.g., microphone), video interface (e.g., camera), or other interface for receiving user inputs (e.g., a mouse or touch display).

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, an AI agent (e.g., 110 in FIG. 1) may receive, via a data interface (e.g., 315 in FIG. 3A, 433 in FIG. 4), a question (e.g., 106 in FIG. 1, 202 in FIG. 2) from a user (e.g., 102.

At step 504, a first neural network language model (e.g., LLM 208 in FIG. 2) may generate a response (e.g., 210 in FIG. 2) based on retrieved information (e.g., 206A-C in FIG. 2) in response to the question. In some embodiments, step 504 may include a retriever (e.g., 125 in FIG. 1, 204 in FIG. 2) retrieving documents from a database (e.g., 119 in FIG. 1).

At step 506, a second neural network based language model (e.g., a large language model as described herein in FIGS. 1-4) may decompose (e.g., using question decomposer 220 in FIG. 2) the question into a plurality of subquestions. In some embodiments, a large language model may generate a response (also referred to as subresponses) to each subquestion. An answer to the user-provided question may then be generated by prompting the large language model to combine the subresponses into a single response. In some embodiments, the language model may be prompted to weight subresponses to core subquestions higher than other subquestion's responses.

At step 508, a classifier model (e.g., subquestion classifier 230 in FIG. 2) may classify at least one subquestion (e.g., classifying into core questions 232, background questions 234, and/or follow-up questions 236) of the plurality of subquestions with a classification label indicative of a type (e.g., core, background, or follow-up) of the at least one subquestion.

At step 510, a computing device (e.g., 300 in FIG. 3; 410, 430 in FIG. 4) may determine a rating (e.g., as calculated using Eq. 1, described herein) indicative of whether the response covers the at least one subquestion associated with the type.

At step 512, the first neural network based language model may revise the response based on additional retrieved information relating to the at least one subquestion when the rating is lower than a threshold. In some embodiment, a response may be shown to a user if a rating is greater than a threshold. A response may be iteratively revised until a set of conditions, e.g., including a rating threshold, are satisfied, at which point an updated response may be displayed to a user.

In some embodiments, methods 500 is applicable in a variety of applications. For example, the complex question received by a neural network model (e.g., LLM 120) may relate to a diagnostic question in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 500 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Data Experiments Results

Example data experiments have been conducted to analyze performance of the RAG system described in FIGS. 1-5 in handling long and open-ended questions. For example, comprehensive question decomposition across different sub-question types enables fine-grained evaluation of RAG systems based on sub-question coverage in both long-form answers and retrieved chunks. Data experiments and evaluation may address two questions: (1) What percentage of core, background, and follow-up sub-questions are covered in the long-form answer? (2) For uncovered sub-questions, is the cause a retrieval failure—where the necessary knowledge is absent from the retrieved chunks—or a generation failure-—where the LLM fails to identify and incorporate the relevant information?

In one embodiment, an LLM (such as GPT-4) may be prompted with few-shot annotated examples to automatically measure sub-question coverage. Given a piece of text and a sub-question, GPT-4 determines whether any part of the text can answer the sub-question. If so, it identifies the specific text fragment that provides the answer. An evaluation comparing GPT-4's judgments with human annotations on 100 samples shows an 83% alignment rate, indicating high accuracy in measuring sub-question coverage.

In one embodiment, for each of the three sub-question types (denoted as type E {core, background, follow-up}), the percentage occurrence of each of the following four scenarios may be calculated:
P_{type}(answered, retrieved): the sub-question is neither covered by the long-form answer nor by any of the retrieved chunks;
P_{type}(answered, retrieved): the sub-question is not covered by the long-form answer, but is covered by at least one of the retrieved chunks;
P_{type}(answered, retrieved): the sub-question is not covered by the long-form answer, but is covered by at least one of the retrieved chunks;
P_{type}(answered, retrieved): the sub-question is covered by both the long-form answer and at least one of the retrieved chunks.

Additionally, four metrics based on the percentage occurrence of the above scenarios:
Metric #1: answer's sub-question coverage rate, expressed as P_{type}(answered).
Metric #2: retrieval's sub-question coverage rate, expressed as P_{type}(retrieved).
Metric #3: the capability to identify core knowledge from retrieved chunks, expressed as

$$\frac{{P}_{core} ( answered , retrieved )}{{P}_{core} ( retrieved )}$$

Metric #4: the potential of getting performance gain by improving retrieval for core sub-questions, expressed as

$$\frac{{P}_{core} ( ¬ answered , ¬ retrieved )}{{P}_{core} ( ¬ answered )}$$

RAG systems typically retrieve ten or more chunks as context for the LLM. When a core sub-question is either covered or not covered in the long-form answer, we calculate the average percentage of retrieved chunks that cover the sub-question (denoted as [symbol] _{covered} and [symbol] _{not covered} Metric #5 captures the correlation between core sub-question coverage in the long-form answer and the frequency of relevant knowledge in the retrieved chunks. This correlation is defined as the difference [symbol] _{covered}- [symbol] _{not covered}, reflecting how effectively the RAG system prioritizes core knowledge in its final response.

The automatic sub-question coverage judgments also identify the specific location in the long-form answer where a sub-question begins to be addressed. This location is expressed as a percentage of the answer length—for example, 20% indicates that the sub-question is addressed starting from the 20th word in a 100-word answer. This location is referred to as the “addressing position” (pos_{type}). Metric #6 uses these positions to measure alignment with human writing habits, where core and background information typically appear at the beginning and follow-up information toward the end. The alignment is quantified by the difference: [symbol] pos [symbol] _(follow-up)))−pos_{core})+(pos_{background})/2.

In one embodiment, the above defined evaluation protocol is applied to assess three widely used RAG-based answer engines: You.com, Perplexity AI, and Bing Chat. Each system is prompted to generate responses of approximately 300 words, with actual responses averaging 272 words. To obtain the corresponding retrieved documents, citation information is extracted, and the content of the referenced web pages is scraped, capturing the knowledge sources used to generate the long-form answers. The distribution of four outcome scenarios across the three sub-question types is summarized in Table 1.

TABLE 1
Comparison of Answer Engine Percentage Occurrences

| Answer Engine | You.com | | | Perplexity AI | | | Bing Chat | | |
|---|---|---|---|---|---|---|---|---|---|
| Sub-Question Type | C | B | F | C | B | F | C | B | F |
| answered, retrieved | 26% | 32% | 56% | 28% | 39% | 61% | 26% | 39% | 59% |
| answered, retrieved | 32% | 48% | 30% | 18% | 41% | 22% | 25% | 47% | 32% |
| answered, retrieved | 9% | 3% | 4% | 9%, | 3% | 5% | 7% | 1% | 2% |
| answered, retrieved | 33% | 17% | 10% | 45% | 17% | 12% | 42% | 13% | 7% |

Metrics #1 through #6 are then used to evaluate the three answer engines, with results shown in Table 2. This multi-metric evaluation offers a detailed view of each system's performance, highlighting strengths and weaknesses in sub-question coverage.

TABLE 2
A Fine-Grained Evaluation of Three Answer Engines

| | | Perplexity | Bing | |
|---|---|---|---|---|
| | You.com | AI | Chat | Ranking |
| Metric #1 | 42% | 54% | 49% | Perplexity AI > Bing |
| (core) | | | | Chat > You.com |
| Metric #1 | 20% | 20% | 14% | You.com = Perplexity |
| (background) | | | | AI > Bing Chat |
| Metric #1 | 14% | 17% | 9% | Perplexity AI > You.com > |
| (follow-up) | | | | Bing Chat |
| Metric #2 | 65% | 63% | 67% | Bing Chat > You.com > |
| (core) | | | | Perplexity AI |
| Metric #2 | 65% | 58% | 60% | You.com > Bing Chat > |
| (background) | | | | Perplexity AI |
| Metric #2 | 40% | 34% | 39% | You.com > Bing Chat > |
| (follow-up) | | | | Perplexity Ai |
| Metric #3 | 51% | 71% | 63% | Perplexity Al > Bing |
| | | | | Chat > You.com |
| Metric #4 | 45% | 61% | 51% | Perplexity AI > Bing |
| | | | | Chat > You.com |
| Metric #5 | 11% | 53% | 39% | Perplexity AI > Bing |
| | | | | Chat > You.com |
| Metric #6 | 36% | 45% | 60% | Bing Chat > Perplexity |
| | | | | AI > You.com |

All three systems demonstrate a consistent pattern: core sub-questions are more frequently addressed than background or follow-up ones. For example, in Metric #1, You.com covers core sub-questions in 42% of cases (9% direct+33% indirect), while background and follow-up sub-questions are covered at lower rates-20% and 14%, respectively. A similar trend is observed in Metric #2, where retrieved chunks more often support core sub-questions. When retrieved chunks do contain answers, core sub-questions are more likely to appear in the final response. For instance, in Metric #3, You.com includes core answers 51% of the time (33% out of 33%+32%), whereas background and follow-up answers are included at only about 25%.

Metric #4 reveals that all systems could improve by enhancing retrieval performance for core sub-questions. According to Metric #5, all three engines face challenges in converting retrieved core knowledge into final answers. Perplexity AI shows stronger linkage between retrieval and generation, while You.com lags behind, incorporating retrieved core knowledge only 11% of the time. This suggests that enforcing the inclusion of core sub-questions during generation could significantly improve response quality. Finally, Metric #6 shows that Bing Chat better aligns its information structure with human writing habits, placing core and background information earlier and follow-up content later. Structuring responses by sub-question type may further improve answer coherence and completeness.

In one embodiment, sub-question coverage supports systematic evaluation of RAG systems across both retrieval and generation components. End-users perceive effectiveness through answer quality, often judged by completeness and relevance. Existing methods approximate human preferences using LLMs as judges, but direct comparison of long answers presents challenges. Identifying the types of sub-questions addressed in an answer allows for a more robust evaluation framework. An automatic answer quality metric derived from sub-question coverage is introduced and its alignment with human preferences is analyzed.

In one embodiment, a set of 500 non-factoid open-ended questions may be selected from the WebGPT Comparisons dataset, focusing on “why” and “how” questions with long-form answers. Each sample includes a question, two answers, and a human preference score ranging from −1 to 1. Samples with neutral preference scores (zero) are removed, and remaining scores are mapped to preference labels (A>B or B>A) based on sign. Each question is decomposed into core, background, and follow-up sub-questions. For each sub-question, automatic sub-question coverage judgment determines whether a given answer includes a corresponding response, yielding three coverage rates per answer: {c_{core}, c_{background}, c_{follow-up}}.

Correlation between core sub-question coverage (c_{core}) and human preference is analyzed under the assumption that higher core coverage indicates higher preference. Results in Table 3 show that the core-only metric achieves 78% accuracy, significantly outperforming the 50% random baseline. This result also surpasses the LLM-as-a-Judge approach, which prompts GPT-4 to make direct pairwise comparisons, highlighting the effectiveness of using core sub-question coverage to automatically evaluate answer quality.

TABLE 3
Three Automatic Answer Quality Metrics' Prediction Accuracy

| Metric | Accuracy |
|---|---|
| LLM-AS-A-JUDQE | 0.71 |
| Core Only | 0.78 |
| All-Type Hybrid | 0.82 |

In one embodiment, the RAG system may be improved with core subquestions. For example, the RAG may be implemented using LlamaIndex, with a retrieval pool constructed by concatenating all cited sources collected from previously evaluated answer engines. A set of 200 open-ended, non-factoid questions is used for testing. For embeddings, the VectorStoreIndex is employed with the text-embedding-ada-002 model. Retrieval is performed with a top-K value of 10, and each response is generated to be approximately 300 words in length.

System performance is assessed using a win-rate matrix. For each question, responses generated by different systems are compared pairwise using a GPT-4-based evaluator. To eliminate position bias, each pair of responses is judged twice with the order reversed. GPT-4 is used as the evaluator due to its broad acceptance in previous benchmarks and evaluation tools. Alternative evaluation using internally developed metrics is avoided to prevent bias, as those metrics are also based on core sub-question coverage. The comparative results are shown in Table 4.

TABLE 4
Win Rates Between Five Methods

| Method | B | M1 | M2 | M3 | M4 |
|---|---|---|---|---|---|
| B | | 41.5% | 34% | 26.75% | 34.75% |
| M1 | 58.5% | — | 30.5% | 25% | 36.5% |
| M2 | 66% | 69.5% | — | 35.75% | 40.75% |
| M3 | 73.25% | 75% | 64.25% | — | 57.5% |
| M4 | 65.25% | 63.5% | 59.25% | 42.5% | — |

The evaluation shows that all core sub-question-informed systems outperform the baseline. This confirms the effectiveness of integrating core sub-questions at various stages of the RAG pipeline. Among all methods, Retrieval Augmentation delivers the highest win rate, outperforming the baseline at 73.25% and consistently ranking above other approaches. It even exceeds the more complex E2E Augmentation method, which involves generating answers to individual core sub-questions before synthesizing a final response. These findings highlight the effectiveness of retrieving content tailored to core sub-questions and demonstrate that this strategy can be adopted with minimal changes to existing RAG systems.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of an artificial intelligence (AI) agent based on a retrieval-augmented generation (RAG) language model, the method comprising:
receiving, via a data interface, a question from a user;
generating, by a first neural network based language model, a response based on retrieved information in response to the question;
decomposing, using a second neural network based language model, the question into a plurality of subquestions;
classifying, using a classifier model, at least one subquestion of the plurality of subquestions with a classification label indicative of a type of the at least one subquestion;
determining a rating indicative of whether the response covers the at least one subquestion associated with the type; and
revising, by the first neural network based language model, the response based on additional retrieved information relating to the at least one subquestion when the rating is lower than a threshold.

2. The method of claim 1, further comprising:
generating an updated response to the question based on whether the rating is above or below a threshold; and
displaying, to the user, the updated response.

3. The method of claim 1, wherein the plurality of classifications includes: core, background, or follow-up.

4. The method of claim 1, wherein determining the rating is further based on a weight associated with a classification.

5. The method of claim 1, wherein the generating the response to the question further comprises:
generating a subresponse to each subquestion;
generating the response to the question from the subresponses.

6. The method of claim 4, wherein the classification is follow-up and the weight is a negative value.

7. The method of claim 1, wherein a first weight is associated with core questions and a second weight is associated with background questions, and wherein the value of the first weight is greater than the value of the second, and the method further comprising:
determining the rating based on the first weight and the second weight.

8. A system for an artificial intelligence (AI) agent based on a retrieval-augmented generation (RAG) language model, the system comprising:
a memory that stores a first neural network-based language model and a second neural-network based language model and a plurality of processor executable instructions;
a communication interface that receives a question from a user; and
one or more hardware processors that read and execute the plurality of processor-executable instructions from the memory, wherein the plurality of processor-executable instructions are configurable to cause the system to perform operations comprising:
generate, by a first neural network based language model, a response based on retrieved information in response to the question;
decompose, using a second neural network based language model, the question into a plurality of subquestions;
classify, using a classifier model, at least one subquestion of the plurality of subquestions with a classification label indicative of a type of the at least one subquestion;
determine a rating indicative of whether the response covers the at least one subquestion associated with the type; and
revise, by the first neural network language model, the response based on additional retrieved information relating to the at least one subquestion when the rating is lower than a threshold.

9. The system of claim 8, the operations further comprising:
generate an updated response to the question based on whether the rating is above or below a threshold; and
display, to the user, the updated response.

10. The system of claim 8, wherein the plurality of classifications includes: core, background, or follow-up.

11. The system of claim 8, wherein determining the rating is further based on a weight associated with a classification.

12. The system of claim 8, wherein the generating the response to the question further comprises:
generate a subresponse to each subquestion;
generate the response to the question from the subresponses.

13. The system of claim 11, wherein the classification is follow-up and the value of the weight is negative.

14. The system of claim 8, wherein a first weight is associated with core questions and a second weight is associated with background questions, and wherein the value of the first weight is greater than the value of the second, and the operations further comprising:
determine the rating based on the first weight and the second weight.

15. A non-transitory machine-readable medium comprising a plurality of instructions, executable by one or more processors, wherein the plurality of instructions are configurable to cause the one or more processors to perform operations comprising:
receive, via a data interface, a question from a user;
generate, by a first neural network based language model, a response based on retrieved information in response to the question;
decompose, using a second neural network based language model, the question into a plurality of subquestions;
classify, using a classifier model, at least one subquestion of the plurality of subquestions with a classification label indicative of a type of the at least one subquestion;
determine a rating indicative of whether the response covers the at least one subquestion associated with the type; and
revise, by the first neural network language model, the response based on additional retrieved information relating to the at least one subquestion when the rating is lower than a threshold.

16. The system of claim 15, the operations further comprising:
generate an updated response to the question based on whether the rating is above or below a threshold; and
display, to the user, the updated response.

17. The system of claim 15, wherein the plurality of classifications includes: core, background, or follow-up.

18. The system of claim 15, wherein determining the rating is further based on a weight associated with a classification.

19. The system of claim 15, wherein the generating the response to the question further comprises:
generate a subresponse to each subquestion;
generate the response to the question from the subresponses.

20. The system of claim 18, wherein the classification is follow-up and the value of the weight is negative.
